(19) United States
(12) Patent Application Publication
(10) Pub. No.: US 2013/0091063 A1
(43) Pub. Date: Apr. 11, 2013

(54) SYSTEM AND METHOD FOR CREATING, NEGOTIATING, SHARING, PURCHASING AND/OR REDEEMING ELECTRONIC VOUCHERS

(71) Applicants: Juan Carlos Velten, Hillsborough, CA (US); Amit Pradhan, San Francisco, CA (US); Rajesh Shirprabhat Pradhan, San Francisco, CA (US)

(72) Inventors: Juan Carlos Velten, Hillsborough, CA (US); Amit Pradhan, San Francisco, CA (US); Rajesh Shirprabhat Pradhan, San Francisco, CA (US)

(21) Appl. No.: 13/558,958

(22) Filed: Jul. 26, 2012

Related U.S. Application Data
(60) Provisional application No. 61/543,900, filed on Oct. 6, 2011.

(51) Int. Cl. G06Q 99/00

(52) U.S. Cl. 705/80

(57) ABSTRACT

According to some aspects, a method of creating and negotiating a voucher is provided. The method comprises receiving from a first user an identification of an offer and criteria for terms of a voucher associated with the offer, presenting to a second user an identification of the offer, receiving from the second user a first proposal for terms of the voucher, and sending a response to the second user based on a comparison of the first proposal with the criteria for terms of the voucher. When the first proposal meets the criteria for terms of the voucher, the response comprises an indication that the first proposal is accepted, otherwise the response comprises a second proposal. Some aspects include a system for performing the above method and some aspects include a computer readable medium storing instructions that perform the above method when executed by at least one processor.

### CROSS-REFERENCE TO RELATED APPLICATIONS

The present application claims the benefit under 35 U.S.C. §119(e) of U.S. Provisional Application Ser. No. 61/543,900, filed on 6 Oct. 2011, titled “SYSTEM AND METHOD FOR CREATING, NEGOTIATING, SHARING, PURCHASING AND/OR REDEEMING ELECTRONIC VOUCHERS,” which is hereby incorporated by reference in its entirety.

### BACKGROUND

Voucher systems, being systems that provide potential customers of a business with a means to obtain vouchers, are known in the art. In some systems, potential customers may be identified based on past purchasing activities and/or by membership in a mailing list that may provide notifications of voucher offers. For example, with respect to vouchers obtained via the Internet, the business may send e-mails to many people, having identified characteristics of potential customers, indicating that a particular voucher may be purchased.

### SUMMARY

Some embodiments include a method of operating a system for creating and negotiating a voucher, comprising steps of, with at least one server receiving from a first user, an identification of an offer and criteria for terms of a voucher associated with the offer, presenting to a second user an identification of the offer, receiving from the second user a first proposal for terms of the voucher, and sending a response to the second user based on a comparison of the first proposal with the criteria for terms of the voucher, the response comprising, when the first proposal meets the criteria for terms of the voucher, an indication that the first proposal is accepted, and when the first proposal does not meet the criteria for terms of the voucher, a second proposal.

Some embodiments provide a system comprising at least one server configured to store an offer, store criteria for terms of a voucher associated with the offer, receive a first proposal for terms of the voucher from a first user, and send a response to the first user based on a comparison of the first proposal with the criteria for terms of the voucher, the response comprising, when the first proposal meets the criteria for terms of the voucher, an indication that the first proposal is accepted, and when the first proposal does not meet the criteria for terms of the voucher, a second proposal.

Some embodiments provide a tangible computer-readable medium having a plurality of instructions embodied therein, wherein the plurality of instructions, when executed by a processor, cause a machine to perform a method of obtaining an offer and criteria for terms of a voucher associated with the offer, receiving from a first user a first proposal for terms of the voucher, and sending a response to the first user based on a comparison of the first proposal with the criteria for terms of the voucher, the response comprising, when the first proposal meets the criteria for terms of the voucher, an indication that the first proposal is accepted, and when the first proposal does not meet the criteria for terms of the voucher, a second proposal.

The foregoing is a non-limiting summary of the invention, which is defined only by the non-limiting appended claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A illustrates a system suitable for providing a voucher according to some embodiments;

FIG. 1B is a schematic view of an exemplary electronic voucher system according to some embodiments;

FIG. 2 shows an exemplary method of creating and negotiating a voucher, according to some embodiments;

FIG. 3 shows an exemplary method of creating and obtaining a voucher, according to some embodiments;

FIG. 4 shows an exemplary method of negotiating a voucher, the initial terms of the voucher created by a consumer, according to some embodiments;

FIG. 5 shows an exemplary method of negotiating a voucher, the initial terms of the voucher created by a business, according to some embodiments;

FIG. 6 shows an exemplary method of negotiating a voucher according to some embodiments;

FIG. 7 shows an exemplary method of a consumer and a business negotiating a voucher, in accordance with some embodiments;

FIG. 8 is a schematic view of an exemplary interface for creating and configuring a voucher, in accordance with some embodiments; and

FIG. 9 is a schematic view of an exemplary computer system that may be used in connection with any of the embodiments of the invention.

### DETAILED DESCRIPTION

The inventor has recognized and appreciated that conventional voucher systems are typically limited in their flexibility and in their ability to provide relevant offers to potential customers, both in the methods used to target potential customers and in the methods used to allow potential customers to obtain a voucher that suits their needs. The inventor has recognized and appreciated that an improved voucher system may be provided by allowing a customer and a business to negotiate the terms of a voucher, which may allow a customer to purchase a voucher that suits the needs of both the business and the customer. Furthermore, the inventor has recognized and appreciated that by allowing a customer to negotiate a voucher and to share the resulting voucher with other consumers, the customer may act as an advocate for the business, thereby increasing the number of potential customers to the business by, for example, increasing the percentage of people who are offered the voucher who patronize the business, particularly on a repeat basis. However, by providing a practical way to enable individualized negotiations on a large scale, the discounts and other concessions offered by the business may be only those of interest to likely prospects for repeat customers, providing greater benefit to the business with less revenue lost through ineffective discounts. Consumers likewise benefit from such individualized negotiations by acquiring products—whether goods or services—on terms that may be of more value to them than terms directed generically to a larger number of potential consumers.

Accordingly, described herein is a system and method for creating, negotiating, sharing, purchasing and/or redeeming electronic vouchers for the purpose of acquiring or selling products, such as goods and/or services.

Such a system may be used by one or more types of users. Some users may be businesses that sell products to which vouchers may relate. Other users may be consumers who acquire the vouchers. Other users may be administrators of the system or may act on behalf of businesses or other parties to mediate negotiations for vouchers.

In some embodiments, users of the system may create electronic vouchers using a computer, an electronic tablet or a mobile device—or a combination of such devices. Said electronic voucher creators post electronic content created in this manner on a website, a platform and/or an application for the purpose of negotiation with and/or purchase by another user and/or groups of users. This content specifies a good, service, product category and/or service category, a monetary discount on a specified face value and/or other elements regarding a potential transaction for such good and/or service.

In some embodiments, the present invention is a system and a method for creating, negotiating, sharing, purchasing and/or redeeming electronic vouchers as described herein and may be accessed in any suitable way. A user who creates said electronic vouchers and the user exposed to them may have access to an electronic device such as a computer, electronic tablet, portable electronic device, internet enabled TV or console with access to a data source such as, but not limited to, the Internet.

The techniques described herein may provide a flexible way to provide a voucher to a consumer. A voucher generally refers to a right, which may be manifested as a ticket or a document, to engage in a commercial transaction on terms influenced by the terms of the voucher. A voucher may be in any suitable form, such as paper, plastic or electronic, and may specify terms such as a good, service, good category and/or service category, a monetary discount on a specified face value and/or other elements regarding a potential transaction for such good and/or service. The specified terms, which may also include one or more numerical values associated with one or more parameters (e.g., price, discounted rate, etc.) may in part determine how the voucher is redeemed by a consumer that purchased the voucher. For example, a voucher may be redeemed in connection with the purchase of goods and/or services such that the terms of the purchase are established, at least in part, based on terms of the voucher. Exemplary types of vouchers may include any suitable terms, including discounts (e.g., reduce the bill by 10%), goods and/or services that are provided once particular criteria are met (e.g., buy one of a product, get one free), vouchers that may be exchanged for goods and/or services of a particular value (e.g., $50 of groceries at a particular store), etc.

The terms of a voucher may be described by criteria that indicate the particular transaction that may be enabled by the voucher. Such criteria may include any one or a combination of: a price or range of prices, a discount or range of discounts, indication of a two-for-one offer (or three-for-two, etc.), a free gift (e.g. a free drink with the purchase of a meal), or any other criteria that may specify how a voucher may be used. It should be appreciated that vouchers described herein are exemplary and the techniques described herein may be applied to other types of vouchers, as the particular type of voucher for which the techniques are used is not limited in this respect.

A system as described herein may enable a consumer (such as a customer or potential customer) to negotiate the terms of a voucher with a business. The business may provide an indication of an offer to sell a voucher, for example by displaying details of the offer on a website, and the consumer may choose to purchase the voucher based on the provided offer information, to negotiate the terms of the offer with the business, or to abandon negotiation of the voucher. Negotiation of the offer between the consumer and the business may result in one or more terms of the offer being adjusted (e.g. the size of a discount), which may result in a new offer that is acceptable to both the consumer and the business. Though, such a process may proceed through any suitable number of iterations until agreement is reached or the process ends based on input from one or both of the consumer or business. Though, once the new offer has been selected, the consumer may purchase the voucher indicated by the new offer. The new offer may also be shared with additional consumer, who may also purchase the voucher indicated by the new offer. Accordingly, a voucher that suits the needs of both the business and the consumer may be created and purchased by the customer, and may also be provided to other consumers.

Negotiation between a consumer and a business may be performed automatically, at least in part. For example, a business may provide an indication of parameters that indicate the possible vouchers the business is willing to sell, which may be used, at least in part, to automatically negotiate offers with one or more consumers. Such parameters may be a subset of the offer criteria described above, and indication of the parameters may, for example, allow the business to define terms of a voucher that are eventually arrived at through negotiation, such as the discounts that a voucher may offer as a function of the price of the voucher, free gifts for which the voucher may be redeemed based on how many vouchers are purchased, etc. The system may use the indication of these parameters to select terms for a voucher to present to a user seeking to negotiate a voucher. Accordingly, the business may ensure that vouchers having particular qualities may be sold to consumers in an automated fashion.

Following below are more detailed descriptions of various concepts related to, and embodiments of, methods and apparatus associated with a system of negotiating vouchers. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

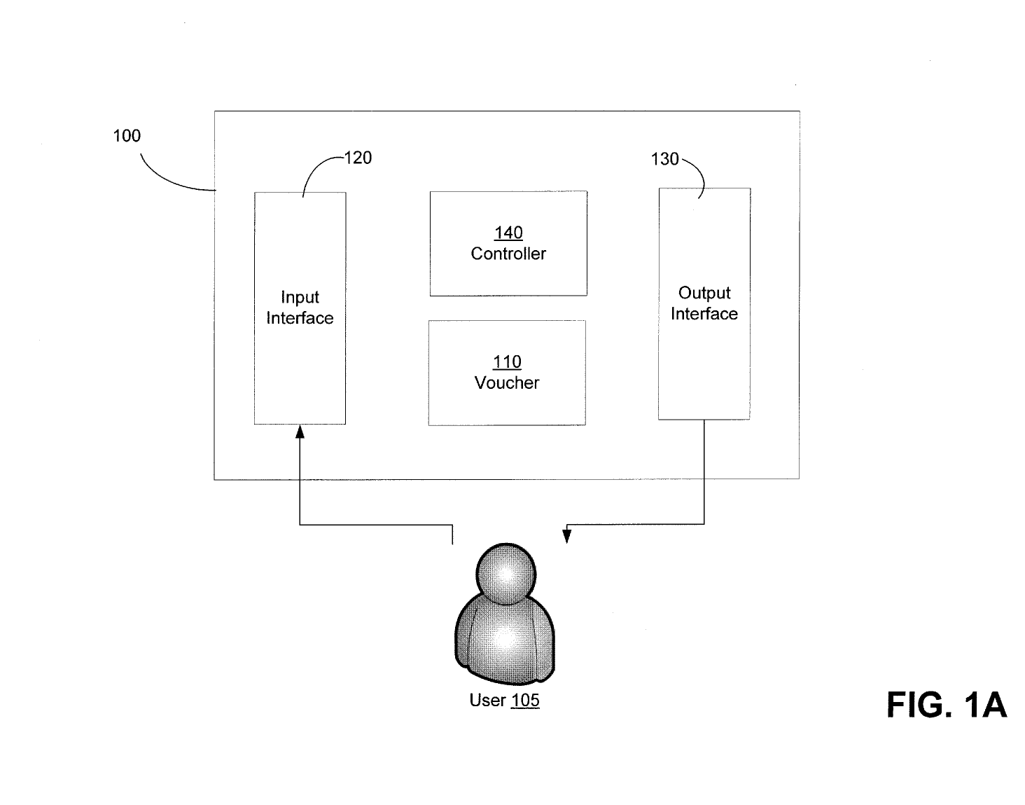

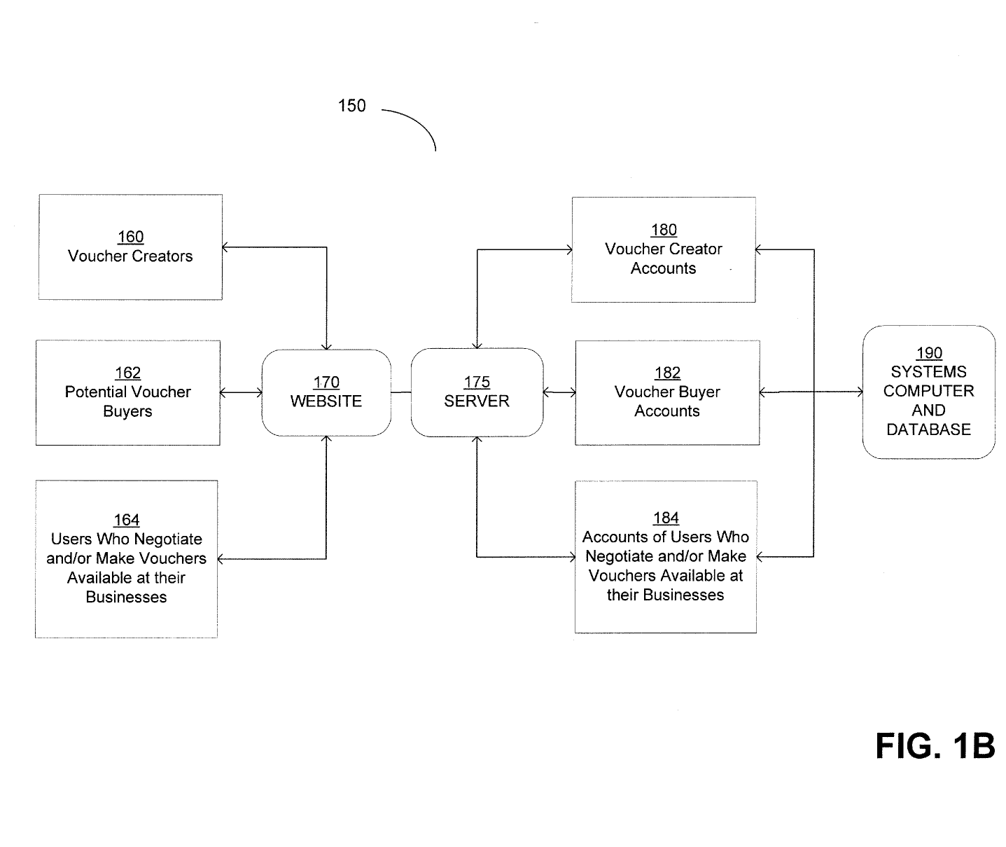

FIG. 1A depicts a schematic view of a system 100 suitable for providing an electronic voucher according to some embodiments. In particular, system 100 is configured to provide a voucher 110, information relating to which may be provided to one or more users, such as user 105.

In this example, voucher 110 is an electronic representation of a voucher. Information stored as voucher 110 may be stored in a database or other suitable electronic form. Such information, (i.e., the voucher) may be distributed to one or more locations, in electronic or other form, to allow voucher 110 to be bought, sold, traded, redeemed, or otherwise processed. For example, a voucher, once issued, may be communicated to a business that has subscribed to have system 100 issue vouchers on its behalf. Likewise, voucher 110 may be communicated to a customer who has purchased it such that it can be redeemed. The specific mechanism by which such a voucher, once issued, is processed are not critical to the invention, and any suitable processing including conventional electronic commerce systems, may be used.

System 100 may include an output interface 130 capable of providing information relating to a voucher to a user. Such an output interface may be implemented in any suitable way, including through the use of a web browser on a computer or smart phone. For example, output interface 130 may include a display device connected to a computer configured to provide information to a user relating to voucher 110. Output interface 130 may also include other output devices such as a mobile phone, a tablet computer, a printer or any other suitable device for presenting information to a user. Information provided to a user relating to the voucher may include, as non-limiting examples, an indication of the terms of the voucher, an identification of an offer associated with the voucher, an indication that the voucher has been purchased, information that allows the user to redeem the voucher, etc. Some of these examples are described in further detail below.

System 100 also includes input interface 120 that allows user 105 to interact with system 100, and in particular, to interact with voucher 110. Such interaction may include querying the system for information on the voucher, providing an indication that the user wishes to purchase the voucher, etc. Input interface 120 may be any one or a combination of input devices capable of receiving user input, and may depend on the type of input the system supports. For example, input interface 120 may include one or more keyboard devices that allow a user to interact with the system. It should be appreciated that input interface 120 may include any type of input component or device, alone or in any combination, that allows a user to input information in any number of different ways, including but not limited to keypad, keyboard, touch screen, mouse, writing pad, microphone, etc., some examples of which are discussed in further detail below.

Voucher 110 includes one or more terms that may be presented to the user based on any number and/or type of factors, including prior interactions between the user and the creator of the voucher, whether an offer has been identified in association with the voucher, etc. Some examples of the terms of vouchers, and the factors that may determine which terms are presented to a user, are described in further detail herein. Voucher 110 thereby may comprise one or more terms, that describe the manner in which the voucher can be redeemed, which, as described above, may be in connection with the purchase of goods and/or services such that the terms of the purchase are established, at least in part, by the terms of the voucher. It should be appreciated that voucher 110 may be a combination of software and hardware (e.g., program instructions stored on at least one computer readable medium that perform, at least in part, operations based on the voucher when executed on one or more processors), and that providing voucher 110 to the user may involve software and/or hardware methods (e.g., printing a representation of the voucher, emailing a link that may be activated by a user to redeem the voucher, etc.).

System 100 also includes controller 140 to control one or more aspects of the functionality of the system, including negotiation of the terms of voucher 110. For example, controller 140 may include one or more processors for executing software, firmware or microcode programmed to control and/or perform some functionality of output interface 130 and/or input interface 120 and to process voucher 110. Controller 140 may include one or more processors, control units, memories, interconnections and/or other hardware or software functionality to allow communication and interaction between the components of system 100. Controller 140 may be formed from any combination of hardware, software and/or firmware to facilitate operation of the system and to execute operations based on voucher 110, some examples of which are described herein.

In the example of FIG. 1A, user 105 may be any person that interacts with system 100. For example, user 105 may be a person attempting to negotiate and/or purchase a voucher. Alternatively or additionally, user 105 may be a person that defines a commercial offer with which a voucher may be associated or establishes criteria for terms of that voucher. As a further example, user 105 may be a person that mediates negotiation for a voucher or otherwise controls aspects of system 100.

FIG. 1B illustrates a schematic view of an electronic voucher system according to some embodiments. In particular, system 150 provides a system that connects voucher creators 160, potential vouchers buyers 162, and users who negotiate and/or make vouchers available at their businesses 164 through a website 170. In this example, website 170 is capable of providing user accounts to these users. Those accounts may be associated with specific roles recognized by the system, such as voucher creator, potential voucher buyer or voucher negotiators. Accounts associated with different roles may have different capabilities, reflecting different operations performed by users in different roles.

Such a website may be implemented in any suitable way, including using techniques as are known in the art. In this example, website 170 is coupled to server 175, which may be a web server (e.g., an Apache web server), or any other suitable server device capable of providing website 170 to a user. Server 175 provides user accounts, including voucher creator accounts 180, voucher buyer accounts 182 and accounts of users who negotiate and/or make vouchers available at their businesses 184. These user accounts may provide a way for users 160, 162 and 164 to authenticate access to the server by accessing accounts 180, 182 and 184, respectively. For example, a voucher creator may be provided with user authentication information (e.g., a username and a password), that allows the voucher creator to access a voucher creator account, for example by accessing website 170 and entering the user authentication information into a web page.

Access to an account may allow a user to store information including, but not limited to, personal information (e.g., name, address, interests, etc.), business information (e.g., company name, company address, etc.), billing information (e.g., credit card number(s), billing zip code(s), etc.), etc System 150 may store data, including account information, via systems computer and database 190, which may provide any suitable means for storing information, including but not limited to a relational database, structured files (e.g., XML) stored on a non-volatile medium, etc.

Systems computer and database 190 may also include software and/or hardware programmed to provide one or more functions that relate to vouchers. Such functions may include voucher creation, voucher negotiation, configuration of terms associated with a voucher, configuration of an offer associated with a voucher, distribution of vouchers, etc. some of which are described in more detail below.

System 150 may be accessed by users, such as voucher creators 160, to create accounts (i.e., to ‘register’). Creators of electronic vouchers register their participation in the system website, platform and/or application by providing certain data directly into the system and/or via a third party sign-on system. This data can include, but is not limited to, name, username, password, electronic email address, demographic information, lifestyle information, financial information, contact information, preferences, answers to questionnaires and/or surveys. Information provided by a voucher creator may also relate to the voucher itself, including a commercial offer to which the voucher applies and criteria to be used by the system in negotiating the voucher. The system may store some or all the data given by creators of electronic vouchers or by third party sign-on systems for the purpose of maintaining an account for creators of electronic content. Other users of system 150 may access the system for the purpose of viewing said electronic vouchers without providing any information or creating an account.

In some embodiments, users who access the system for the purpose of consultation, negotiation, purchase and/or making said vouchers redeemable at their business register their participation in the system website and/or application by providing certain data directly into the system and/or via a third party sign-on system. This data that can include, but is not limited to, name, username, password, electronic email address, demographic information, lifestyle information, financial information, contact information, preferences, answers to questionnaires and/or surveys. The system may store some or all the data given by said users or by third party sign-on systems for the purpose of maintaining an account for them.

The website, platform and/or application allows users to negotiate some or all of the elements of said electronic vouchers for the purpose of reaching an agreement on the monetary value and/or elements that compose the proposed transaction. For example, a voucher creator may have system 150 negotiate on its behalf one or more terms associated with a voucher with a potential voucher customer. The website, platform and/or application also allows users to indicate an intention to purchase said electronic vouchers, post said electronic vouchers on other websites and/or applications and/or purchase said electronic vouchers. This may be performed, for example, by system 150 providing a web link to a user, who may then publish that link on another website and/or via a social networking application.

Other users may then access such a link, or any other suitable mechanism, to obtain information on an electronic voucher that has been negotiated. In some embodiments, this capability allows a first user to negotiate a voucher and share the results of that negotiation with friends or others potentially interested in the offer associated with the voucher. In this way, a second user may take advantage of the voucher negotiated by the first user and purchase the voucher.

The website, platform and/or application allows users to purchase said electronic vouchers. In some embodiments, such purchases may be without condition. Though, in other scenarios sale of vouchers may be limited to circumstances when certain conditions are met. For example, sales of vouchers may be conditioned on a maximum number of vouchers being sold for a specific offer. As another example, vouchers may be sold only to users having specified demographic or other characteristics. As yet a further example, sale of vouchers may be conditioned on the purchaser having an association with an entity offering the voucher or who negotiated the voucher. These conditions may be specified by the voucher creator, by the system or in any other suitable way.

When a voucher is purchased, the website, platform and/or application enables delivery of purchased electronic vouchers in forms that include, but are not limited to, printable vouchers, on-screen image of said electronic voucher, direct deposit of electronic voucher in a user's third party account, electronic mail, a clickable link, and/or a numeric or alphanumeric code delivered in any electronic or paper media.

System 150 may power a negotiation between electronic voucher creators and users who access the system for the purpose of negotiating, making redeemable at their business and/or purchasing said vouchers by allowing them to interact. Interaction includes, but is not limited to, actions such as editing and responding to propositions and/or changes made by the other user on any or all the elements that compose said electronic voucher. Said actions may happen in real time or with a time delay. The amount of delay may be determined by operation of the system, such as latencies in processing I/O requests on server 175 or in communicating over a network (such as the Internet) through which users access website 170. In other embodiments, the time delay may be intentionally introduced. For example, the system may delay responses to proposals to modify terms of a voucher from negotiators of vouchers as a way to encourage the negotiators to quickly accept proposed terms for a voucher. The delay may be determined in any suitable way. As a specific example, the delay may increase by either predetermined or random amounts for each response made during a negotiation session.

The system enables said users to interact with each other in this manner one or multiple times. The system can also power said negotiation in an automated manner if the creator of an electronic voucher chose to make negotiation automatic. Website 170, or other suitable user interface may include one or more mechanisms to negotiate and/or make a voucher redeemable. These mechanisms can take a form that includes, but is not limited to, fields, pull-down menus, multiple choice options, drag-on icons, electronic calculators, voice/video recordings, and/or electronic rulers. When a creator(s) of an electronic voucher and user(s) who access the system for the purpose of negotiating, purchasing and/or and making such voucher redeemable at their business agree on all the elements of said voucher, the system enables the latter user to activate said electronic voucher at their business on whatever form said user chooses. Accordingly, though not illustrated in FIG. 1B, system 150 may include one or more interfaces to data processing systems operated by those businesses. Those interfaces may take any suitable form, including using conventional mechanisms for electronic communication. As a specific example, information communicated to activate a voucher may be transmitted over a public network such as the Internet. Communications over a public network may be encrypted or otherwise secured. Though, the specific mechanism by which this communication occurs is not critical to the invention.

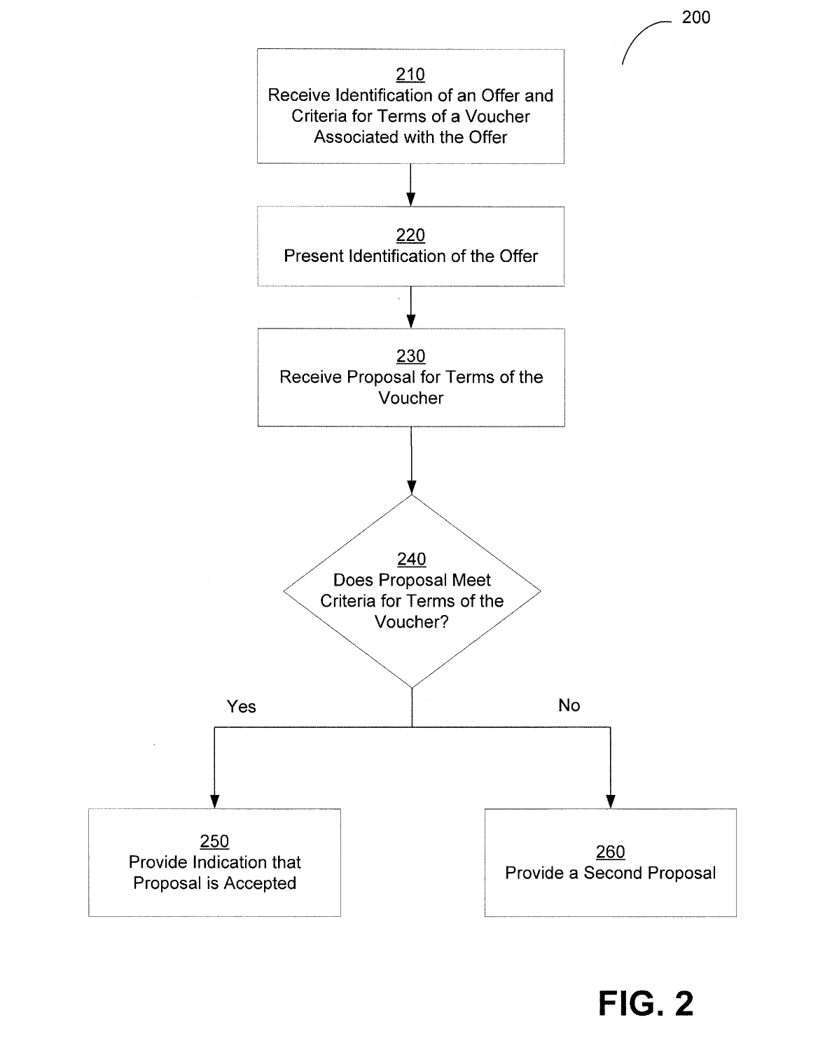

FIG. 2 illustrates a method of creating and negotiating a voucher, according to some embodiments. Method 200 may be performed to negotiate some or all of the elements of the voucher for the purpose of reaching an agreement on, for example, the monetary value and/or elements that comprise the proposed transaction. For example, method 200 may be performed by a server computer to achieve the negotiation of the price of a discount voucher between a customer (or potential customer) of a business, and a representative of the business.

Method 200 provides a negotiating process for a voucher by comparing a proposal for terms of the voucher with criteria for terms of the voucher associated with an offer. This may allow a business and a customer, for example, to arrive at a mutually beneficial arrangement, as described above. Method 200 may be performed by any suitable device, including by a server computer. Such a server may be a component of system 100 (FIG. 1) or system 150 (FIG. 1B). Though, it should be appreciated that the method 200 may be performed on any suitable computing device(s), and that different acts depicted in FIG. 2 may be performed on different computing devices.

In act 210, identification of an offer and criteria for terms of a voucher associated with the offer are received by the server. The criteria for terms of a voucher indicate terms that the creator of the offer is willing to accept during negotiation of the voucher. The criteria may describe one or more parameters, such as price, a quantity of a product for which the voucher may be exchanged, a discounted rate for a good and/or service, a number and type of free goods and/or services, etc. The criteria for terms of a voucher may include indications of values of parameters in any suitable way, e.g., a static value, a value that depends on the value of one or more other parameters, a range of values, etc.

As a non-limiting example of the above concepts, the criteria for terms of a voucher may indicate a price and a discounted rate, and may further provide multiple price ranges that each depend on the discounted rate. Such criteria may thereby indicate an offer in which the discounted rate provided by the voucher depends upon the price of the voucher (e.g., spend $10-$49 and get a 10% discount, spend $50 or more and get a 20% discount). Alternatively or additionally, a discounted rate may depend on the inclusion and/or exclusion of incentives and/or conditions, which may have a value associated with them (e.g. pre-buy additional product for $5) or may have no value (e.g. share the deal with three friends). However, in general any number of criteria may be specified, and the criteria may indicate any number of parameters expressed in any suitable way.

This information may be provided in any suitable format. As an example, identification of the offer may include identification of a file and/or database contents (e.g., stored on a server) that is associated with the offer (e.g., a key value in a database that identifies data associated with the offer). The file and/or database may contain information that can be presented in an attractive way to a consumer potentially interested in the subject of the offer. For example, the file and/or database may include, or provide a mechanism for a server to access, text describing the offer or product, such as a good or service that is the subject of the offer, pictures, audio and/or audio video content relating to the offer.

This information may then be presented, such as via website 170, in a format that allows a user interested in purchasing a voucher to identify offers for which vouchers are available. The offers may be presented in any suitable format to aid a user in identifying offers of interest to that user. The offers, for example, may be indexed or catalogued. Any suitable criteria may be used for such indexing or cataloging, including location, value or interest categories of the offer. A search interface may be presented to these indexes or catalogs through which a user may request information on an offer. Alternatively or additionally, offers may be presented by the system automatically to users based on activities or other characteristics of the users. Accordingly, it should be appreciated that the specific mechanism by which a user becomes aware of an offer is not critical to the invention.

Regardless of the format in which it is presented, information about the offer may allow a user logged into a website to select, by sending an indication to the server, a previously created offer. Selection of the offer may also include information sent to the server, such as data provided when a user clicks on a suitably configured web link. Selection of the offer may be provided by any type of user, including by a customer, potential customer, business owner/representative, etc. and/or may be provided using any suitable device, such as a server or client computer, a mobile phone, tablet computer, etc. Though, it's not a requirement that the offer of interest be selected by user input. In some embodiments, an offer of interest may be selected automatically by the system.

In act 220, the selected offer is presented to the user, for example by the server providing data (such as data received in act 210) to a web page, email, text message and/or instant message, etc. Alternatively or additionally, the user may be notified that a selected offer is available on the server.

Though, it should be appreciated that the order of the acts illustrated in FIG. 2 is illustrative rather than limiting. As an example of possible variation, a user interested in purchasing a voucher may provide input to the system identifying an offer that would be of interest. In response, the business associated with the offer may be notified.

Regardless of the specific steps by which the system determines that there is a first user making an offer potentially of interest to a second user, the system may then present the offer to the second user to begin a negotiation session relating to the terms of a voucher associated with the offer. Presenting the offer may include none, some or all of the criteria for terms of the voucher and/or may include a textual description of the offer. In some embodiments, presentation of the offer may be configured by the creator of the offer, which may be a consumer, such as a customer or potential customer, or a representative of a business. For example, a business representative may configure criteria for terms associated with an offer for a discount voucher, as described above, but may configure the presentation of the offer to identify only a description of the business. Such a configuration may be advantageous to the business during subsequent negotiation with one or more customers over the terms of one or more vouchers associated with the offer.

In act 230, a proposal for terms of the voucher is received by the server. The proposal may be provided by any user, although in a preferred embodiment the user providing the proposal is a different user to the user that created the offer in act 210. For example, the server may receive an indication of an offer in act 210 from a business representative, and may receive a proposal for terms of a voucher from a consumer in act 230. The proposal may be expressed in any form, and may be provided using any suitable technique. For example, the proposal may be created by a user manipulating one or more web pages and submitting an indication of the proposal. The proposal may also be created by a user activating a link, for example, a link displayed through a social networking application or web page. However, the above are provided merely as examples, and any suitable technique for presenting a proposal may be employed, using any suitable device.

In act 240, the server determines whether the proposal received in act 230 meets the criteria for terms of the voucher received in act 210. Act 240 therefore determines how the negotiation is to proceed; whether there is agreement over the terms and therefore that the negotiation has concluded, or whether the negotiation may continue. If the proposal meets the criteria, the terms have been agreed upon and the voucher may be purchased by a user. In some embodiments, the user who purchases the voucher is the same user who provided the proposal for terms of the voucher in act 230. Though, there is no requirement that purchase of a voucher be limited to users who negotiate the voucher, and some embodiments may include a mechanism by which other users are notified of a voucher for which terms have been agreed through negotiation.

If the proposal does not meet the criteria there may be further negotiation, as described below. However, if the proposal meets the criteria in act 240, an indication that the proposal is accepted is provided to the server in act 250. The indication may be provided in any suitable way, such as by a user clicking a link on a web page that provides information to the server. The acceptance of the proposal may subsequently result in the user from whom the proposal was received in act 230 purchasing a voucher under the terms represented by the proposal, the process of which is described in further detail below.

If the proposal does not meet the criteria in act 240, the process of negotiation may continue or may be ended by action of the user or the system. In a scenario in which negotiation continues, a second proposal may be provided to the server in act 260. The second proposal may be, for example, provided by a user clicking a link on a web page that provides information to the server, or may be provided automatically by any suitable device, including the server. Such automatically providing of a second proposal may allow automated negotiation of a voucher. For example, a consumer may define criteria for terms of a voucher and a business may provide a proposal that does not meet the criteria. The server may be configured (e.g., it may have been configured by the business) to automatically provide a second proposal to the consumer based on the first proposal not meeting the criteria.

The method 200 may proceed from act 262 to further acts, not illustrated in FIG. 2, constituting further negotiation and/or acceptance of the terms for a voucher. In an embodiment in which a user specifies the terms of the second proposal at act 260, method 200 may loop back to act 240, where the process may again branch based on whether the proposal meets the criteria for the voucher. If the system automatically specifies the terms of the second proposal, method 200 may proceed to act 250, where the user may accept the second proposal. Though, if the second proposal does not meet the criteria for terms of a voucher and/or is not accepted by the user, one or more of the acts of method 200 involving making a proposal and obtaining an acceptance of that proposal may be repeated one or more times until negotiation concludes with agreement on the terms of the voucher or is ended.

As described above, method 200 illustrates a method of creating and negotiating a voucher, and each step may be performed by any suitable user. In some embodiments, to be described in further detail below, one or more users associated with a business provide the identification of the offer and the criteria for terms of the voucher, and a consumer provides the proposal for terms of the voucher. In other embodiments, to be described in further detail below, a consumer provides the identification of the offer and the criteria for terms of the voucher, and a user associated with a business provides the proposal for terms of the voucher.

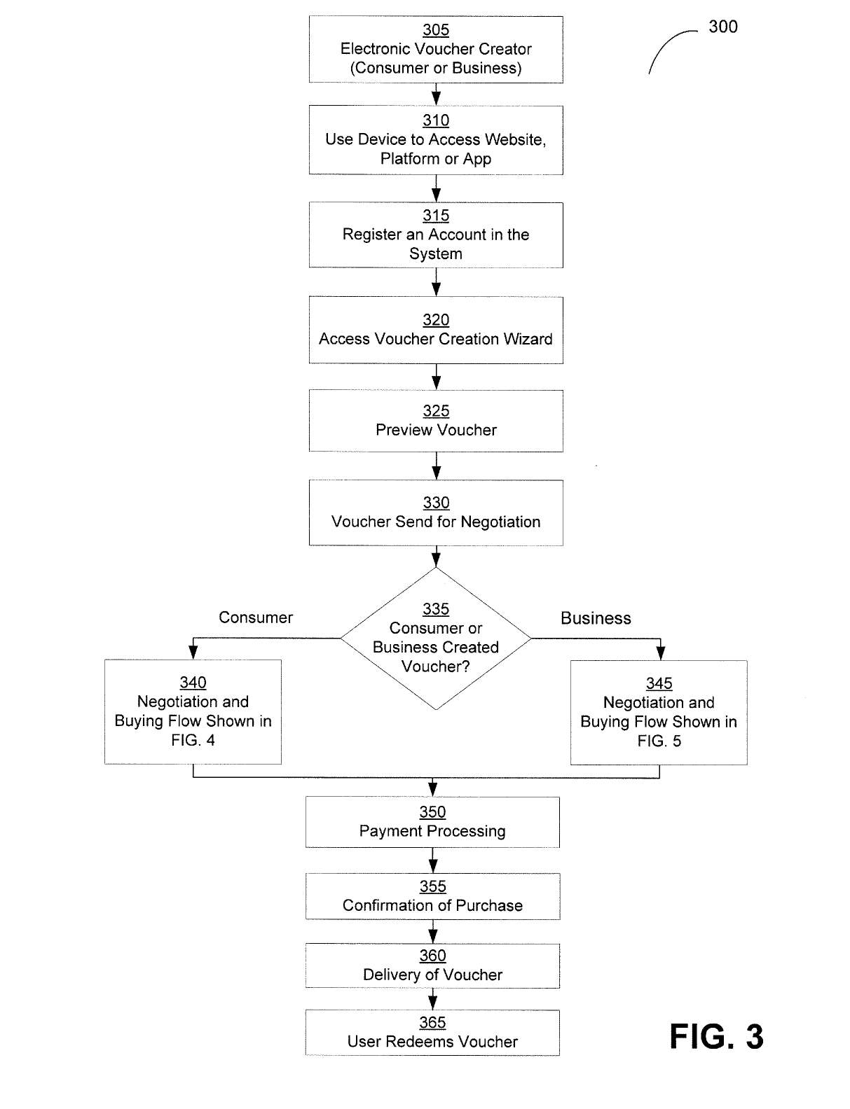

FIG. 3 illustrates a method of creating and obtaining a voucher, according to some embodiments. Method 300 may be performed by a consumer (i.e., a person or other entity that would use a voucher, such as a customer or potential customer of a business that will redeem a voucher), and/or may be performed by one or more users associated with a business. Since, in the example of FIG. 3, a voucher is purchased by a consumer, acts 350, 355, 360 and 365 may be performed by a consumer, whereas the other acts of method 300 may be performed by either a consumer or a user associated with a business.

In act 310, the user, being a consumer or a business representative, operates a suitable device to access the voucher creation and negotiation system. The system may be accessed in any suitable way, such as via a website or via an application installed on a computer, mobile phone, tablet computer, etc.

In act 315, the user registers an account in the system. Registering an account may include the user providing information to the system, which may include, but is not limited to, name, username, password, electronic email address, demographic information, lifestyle information, financial information, contact information, preferences, answers to questionnaires and/or surveys. The system may store some or all of the data given by the user or by third party sign-on systems for the purpose of maintaining an account for the user. Registering an account in the system may be an act that each user only performs once; in subsequent uses of the system the user may provide an indication of authentication information (e.g., username, password) provided when registering an account.

In act 320, the user provides information that creates a voucher. In this specific example, act 320 is performed by the user accessing a voucher creation wizard. The “wizard” may be a software program configured to guide the user through steps in the voucher creation process. However, it should be appreciated that any suitable mechanism may be used to obtain from a user information for creating a voucher. In this example, the voucher creation wizard may include a user interface configured to provide a convenient way for the user to create a voucher, and may provide a different layout and/or functions based on whether the user has identified themselves to be a consumer or associated with a business. An exemplary voucher creation wizard is described in further detail below.

In some embodiments, to create an electronic voucher, the creator of said voucher accesses a form or set of forms in the system. Said forms may take a format that includes, but is not limited to, a questionnaire, a visual representation of an electronic voucher, a set of sequential screens and/or a group of icons. The creator of said electronic voucher completes and/or fills in information in the said forms. This information may include, but is not limited to, the monetary face value of said electronic voucher, a discount expressed as a percentage off said face value, a date or range of dates for which said electronic voucher may be valid, a good and/or service, a good and/or service category, images such as photos or illustrations, and/or conditions and/or incentives or other transactional elements that said electronic voucher may include. The creator of said electronic voucher may also indicate which elements of said voucher affect the value of the other elements on it.

In act 325, the system presents the user with a preview of the electronic voucher created using the voucher creation wizard in act 320, which the user may edit and/or approve. The preview may display the voucher in a manner equivalent to how other users of the system may view the voucher once it is created. This may be useful, for example, for a business to preview how a voucher will appear to consumers before the voucher has been made available and/or visible to consumers. As a specific example, the preview of the voucher in act 325 may contain a description of the offer, whether of goods or services, to which the voucher pertains. Terms of the voucher may also be visible. Because the terms are not negotiated at the preview stage depicted in act 325, the terms presented in the preview may reflect an initial proposal for the terms of the voucher offered to users interested in purchasing such a voucher. Though, any suitable representation of the terms of the voucher may be included, or omitted, in act 325.

In act 330, the voucher is created and is sent for negotiation. Any suitable technique may be used to make a voucher available for negotiation. In some embodiments, sending a voucher for negotiation may entail posting an indication on a website or in conjunction with any other information source, that a voucher is available for negotiation and potential purchase.

As described above, method 300 may be performed by a consumer interacting with a system for voucher negotiation or may be performed by one or more users associated with a business interacting with such a system. The specific acts of the method to perform negotiation and buying of a voucher may depend on whether the user is a consumer or is associated with a business, as determined at act 335. The methods to perform negotiation in each case, which occur in acts 340 and 345, will be described in further detail below. Whether a user is a consumer or is associated with a business may, for example, be determined by user action (e.g., by the user clicking on an appropriate link on a website) and/or may be determined based on information associated with the user (e.g., by the system examining user account information). As an example of the latter, there may be two types of accounts: consumer and business accounts, and the type of account that the user has used to log into a website may allow the system to determine whether the user is a consumer or is associated with a business.

Irrespective of the method used to perform negotiation and buying of the voucher, in act 350 payment processing associated with the purchase of the voucher by a consumer is performed. Payment processing may be performed by any system, and may be a distinct system from that used to provide a user interface to the user and/or to the system used to store data, such as account data, voucher data, etc. Any suitable payment processing mechanism may be used, including mechanisms as are known in the art. For example, a user may enter a credit card number into a user interface, or may choose previously stored credit card information, which may then be processed by a third party credit card processor for purchase of a voucher.

Irrespective of how the payment processing is performed, the consumer may receive confirmation of the purchase of the voucher in act 355. Any suitable technique for providing confirmation may be used, including sending a message that is displayed via a user interface and/or a text message and/or email indication of purchase confirmation.

In act 360, the purchased voucher is delivered to the consumer. Any suitable technique for delivering a voucher, including techniques as are known in the art, may be used. In some embodiments, the system presents the buyers of said electronic vouchers with several options for receiving said vouchers. These options may include, but are not limited to, printable vouchers, on-screen image of said electronic voucher, direct deposit of electronic voucher in a user's third party account, electronic mail, a clickable link, and/or a numeric or alphanumeric code delivered in any electronic or paper form. Accordingly, it should be appreciated that in some embodiments, act 360 may entail a physical delivery of the voucher. In other embodiments, the delivery may entail transmission of electronic information, and may be performed as part of or in conjunction with sending the notification in act 355.

In act 365, the consumer redeems the purchased voucher, the process of which may depend on the method of delivery used to provide the voucher to the consumer. For example, a voucher delivered via a clickable link on a web page may be redeemed by the user completing a transaction through a website after clicking on the link. Alternatively or additionally, redeeming a voucher may entail entering a code assigned to the voucher in a website requesting payment for completing purchase of a good or service that is the subject of the offer associated with the voucher. As another example, a printable voucher may be redeemed by giving a printed copy of the voucher to a representative of a business in exchange for goods and/or services that are the subject of the offer. The voucher may also be redeemed by the consumer presenting a form of personal identification that the business matches against a database in the system. Regardless of the manner in which the voucher is redeemed, redemption of the voucher may allow the user redeeming the voucher to alter the terms of a commercial transaction relating to purchasing a good or service that is the subject of an offer. For example, the voucher may be in the nature of a coupon, which, when applied to the purchase reduces the purchase price. Though, the voucher may be in the form of advance payment such that when redeemed, it satisfies some or all of the required payment for the good or service. In yet another example, the voucher may represent entitlement to an ancillary product or service that is provided at no or at reduced cost when another good or service is purchased. However, the above are provided as examples, and any suitable redemption method may be used.

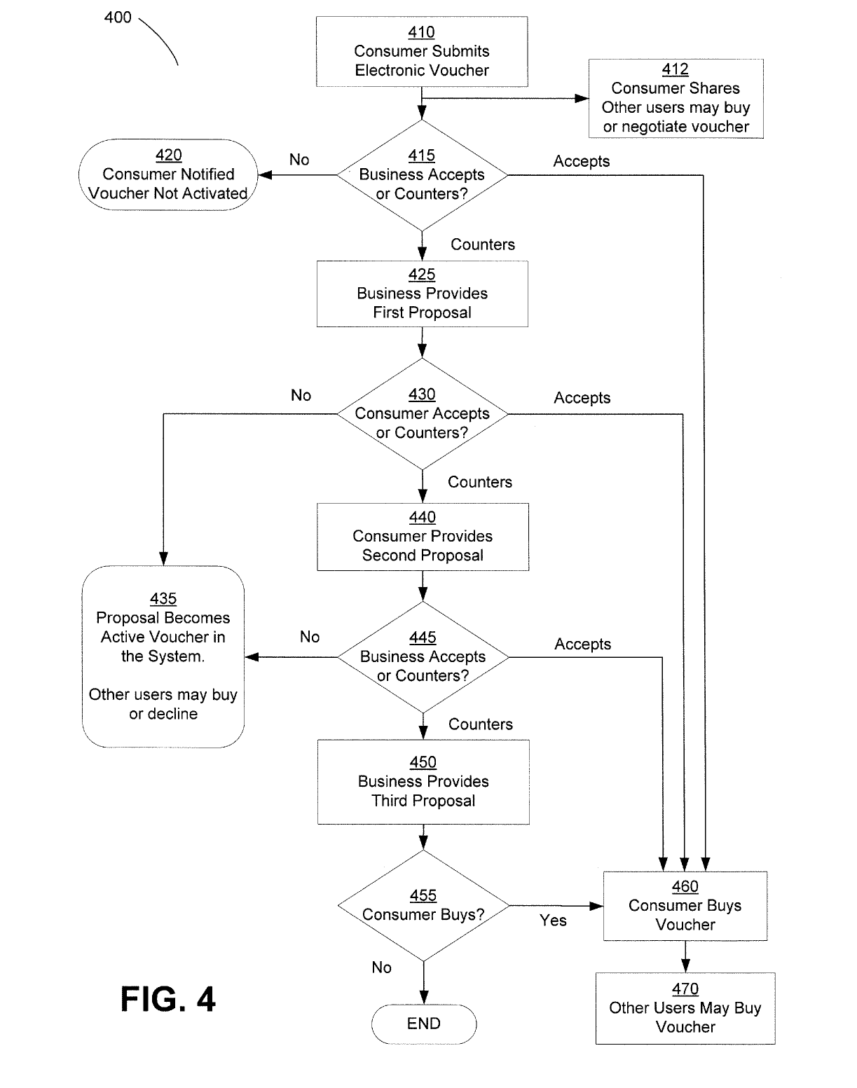

FIG. 4 illustrates a method of negotiating a voucher wherein the initial terms of the voucher are created by a consumer, according to some embodiments. Method 400 may represent processing in act 340, as described above in connection with FIG. 3. In this example, a voucher may be created by a consumer when the consumer wishes to propose a potential transaction to a business. For example, a consumer may wish to purchase goods from a particular business and may create a voucher in order to propose terms of a transaction with the business, e.g., the consumer may propose purchasing $100 of goods with a 10% discount and may accordingly create a voucher with a price of $90 that can be exchanged for $100 of goods with the business.

In method 400, the consumer submits an electronic voucher to the system in act 410. This act may be performed, for example, via the techniques described above in relation to FIG. 3. The electronic voucher submission may indicate an offer and terms of the voucher created by the consumer. As described above, terms of a voucher may describe values for one or more parameters, such as price, a quantity of a good for which the voucher may be exchanged, a discounted rate for a good and/or service, a number and type of free goods and/or services, etc. The terms of a voucher provided at act 410 may include indications of values of parameters in any suitable way, e.g., a static value, a value that depends on the value of one or more other parameters, a range of values, etc.

In act 412, the consumer may share the electronic voucher with other users. This may be performed, for example, using the same website or application that the consumer used to create the electronic voucher, but may also be performed by sharing a web link with other users via, for example a social networking website or application. Sharing the electronic voucher may allow other users to use the same electronic voucher and/or to perform negotiation with the business themselves. This may be beneficial to other users to save them the time of creating a new electronic voucher if the configuration of the electronic voucher being shared is of interest to one of the other users.

In act 415, the business accepts, rejects or counters the submission of the electronic voucher provided in act 410. The decision to accept, reject or counter the submission of the voucher by a user associated with the business may be performed in any suitable way. The decision may be automated or may be made manually by a user acting on behalf of a business to which the electronic voucher was submitted in act 410. When done automatically, the system used in performing method 400 may apply one or more criteria supplied by a business to which the submitted voucher is directed to determine whether terms supplied by the consumer in act 410 are acceptable. If not, the system may employ the criteria to identify alternative terms that would be acceptable. When done manually, the system performing method 400 may route the proposal to a user who will manually make a determination on whether to accept the offer or propose an alternative. For example, a user may click on an appropriate link provided by a website, the user may provide a text message to indicate the decision, etc.

Regardless of whether done manually or automatically, if the business rejects the electronic voucher submission, which may occur if the business does not wish to sell a voucher to the consumer having the terms provided in the voucher, the consumer is notified of the business' response in act 420. The notification may be provided to the consumer via any suitable method, such as via a message shown on a web page, an email, a text message, etc. In act 420, no voucher is created for purchase by a consumer as the negotiation process ended with no agreement on the terms of a voucher.

Alternatively, the business may accept the terms of the voucher as provided by the consumer, in which case the consumer may buy the voucher in act 460, which is described in greater detail below. If the business did not reject or accept the voucher submission, the business may provide a first proposal as a counter offer in act 425.

The response to a voucher submission may be provided automatically based on one or more criteria. For example, a representative of the business may configure the system (e.g., by manipulating controls associated with the business' account) to reject, accept or counter the submission of a voucher by a consumer based on the criteria provided in the voucher submission, which may be performed for some or all voucher submission criteria. For example, a business may configure the system to automatically reject vouchers that indicate a discount greater than 30% and to automatically accept vouchers that indicate a discount lower than 5%. A representative of the business may then manually decide whether to accept, reject or counter vouchers that indicate a discount lower than 30% and greater than 5%. However, this is provided merely as an example and any suitable scheme for automatically accepting, rejecting and/or countering the submission of a voucher may be used by a business.

The first proposal provided by the business in act 425 may include any suitable criteria, and may indicate terms of a voucher that the business is willing to accept, as described above. In act 430, the consumer accepts, rejects or counters the business' proposal. This decision may be based upon whether the first proposal meets the criteria for terms of the voucher specified by the consumer when creating the voucher submitted in act 410, as described above in relation to FIG. 2, and may thereby be performed automatically or manually by the consumer.

If the consumer rejects the first proposal, a voucher in accordance with that proposal may nonetheless be of interest to other consumers. Accordingly, in the example of FIG. 4, in act 435 the first proposal is created as an active voucher in the system that any consumer may now purchase. Therefore, although the negotiation process between the consumer and the business did not result in the purchase of a voucher by the consumer, the business indicated terms of a voucher that it would accept, and these terms may be used to create a new voucher. Such a creation of a new voucher may be performed automatically, and/or may be subject to approval by a representative of the business. The system may also be configurable to enable a business to disable the creation of vouchers created in this manner, if desired.

The consumer may accept the terms of the voucher as provided by the business, in which case the consumer may buy the voucher in act 460, as described in greater detail below. If the consumer did not reject or accept the first proposal, the consumer may provide a second proposal as a counter offer in act 440.

The second proposal provided by the consumer in act 440 may include any suitable criteria, and may indicate terms of a voucher that the consumer is willing to accept, as described above. The system may be configured by the consumer to generate the second proposal automatically, for example by applying one or more criteria for terms of the voucher submitted in act 410.

In act 445, the business may accept, reject or counter the second proposal. If the business rejects the second proposal, in act 435 the first proposal may be created as an active voucher in the system that any consumer may now purchase, as described above. Alternatively or additionally, the business may accept the terms of the voucher as provided by the second proposal, in which case the consumer may buy the voucher based on the terms of the second proposal in act 460, as described in greater detail below. If the consumer did not reject or accept the second proposal, the business may provide a third proposal as a counter offer in act 450.

The third proposal provided by the business in act 450 may include any suitable criteria, and may indicate terms of a voucher that the business is willing to accept, as described above. In act 455, the consumer accepts or rejects the business' proposal. This decision may be based upon whether the third proposal meets the criteria for terms of the voucher specified by the consumer when creating the voucher submitted in act 410, as described above in relation to FIG. 2, and may thereby be performed automatically by the system or manually by the consumer.

In the example of FIG. 4, method 400 ends if, in act 455, the consumer does not accept the third proposal provided by the business in act 450. However, it should be appreciated the acts illustrated in FIG. 4 may be repeated any suitable number of times. For example, further proposals may be made. Alternatively or additionally, act 435 may be repeated, with the third proposal made by the business at act 450 replacing the first proposal as an active voucher in the system. Such acts may be repeated iteratively, until both parties indicate, either automatically or manually, agreement with terms for a voucher or some other condition, indicating an end of negotiation is reached. Though, in this specific example, if the consumer accepts the third proposal in act 455, the consumer may buy the voucher based on the terms of the third proposal in act 460, as described in greater detail below.

In act 460, the consumer may buy the voucher having terms as dictated by the negotiation process described above. That is, in the example of FIG. 4, the terms of the voucher that may be purchased in act 460 may be determined by the electronic voucher submitted by the consumer in act 410, the first proposal provided by the business in act 425, the second proposal provided by the consumer in act 445 or the third proposal provided by the business in act 450. Irrespective of how the terms of the voucher for purchase were determined, in act 460 the consumer buys the voucher having these terms. The purchase process may use any suitable technique(s) in which the consumer provides payment information and receives delivery of the voucher, such as those described above in relation to FIG. 3.

In act 470, the voucher purchased by the consumer in act 460 may be made available to other users for purchase. This may be performed, for example, by providing details of the voucher for purchase on a website, though may also be made available via one or more applications running on any suitable device (e.g., client computer, tablet computer, mobile phone, etc.) and/or a social networking website and/or application.

In some embodiments, the system posts approved vouchers for the purpose of negotiating, purchasing, selling and/or sharing said vouchers. The electronic voucher created in this manner is stored in the user's account, published in the system and/or posted, forwarded to another user, groups of users and/or third party websites or applications for the purpose of consultation, negotiation, purchase and/or sharing. The system keeps creators informed on certain actions taken on vouchers by other users or third parties. Users may access the system for the purpose of negotiating and/or making electronic vouchers redeemable at their businesses. The system presents users with the electronic voucher created by the creator and the means to negotiate some or all the elements that compose a voucher and/or make it redeemable at their business. When a creator(s) of an electronic voucher and user(s) who access the system for the purpose of negotiating, purchasing and/or making such voucher redeemable at their business agree on all the elements of said voucher, the system posts the voucher in a form that enables any user to purchase the voucher under the terms indicated on it, by means indicated by the system.

An operator of the system that facilitates negotiation of the terms of a voucher may benefit from the sale of a voucher in any suitable way. For example, in some embodiments, the system may collect a price for the sale of the voucher. The operator of the system may, either manually or automatically, forward a portion of the sale price to the business that will sell or provide a product, such as a good or service, that is the subject of the voucher. Though, the operator of the system may retain a portion of the collected sale price or otherwise obtain benefit asked a commission for the sale of the voucher.

In some embodiments, the system shares some or all the proceeds of the sale of said voucher with the user who negotiated, purchased and/or made said voucher redeemable at their business. Said sharing may take a form that includes, but is not limited to, electronic fund transfers, electronic checks, paper checks, cash, deposit into an account and/or credit in the system or at a third party. A consumer may thereby receive monetary gains by being part of a process that generates a voucher that other consumers then purchase.

It should be appreciated that a negotiation process may include any number of proposals and negotiation steps, and that the exemplary method provided by FIG. 4 merely indicates one such process. In general, a negotiation process may continue indefinitely with a business and consumer repeatedly providing counter proposals until either the business or the consumer accepts a proposal. In some embodiments, the system is configured to impose a limit on the number of proposals that may be provided in a negotiation between a consumer and a business, which may encourage consumers and businesses to promptly determine terms of a voucher that is agreeable to both parties.

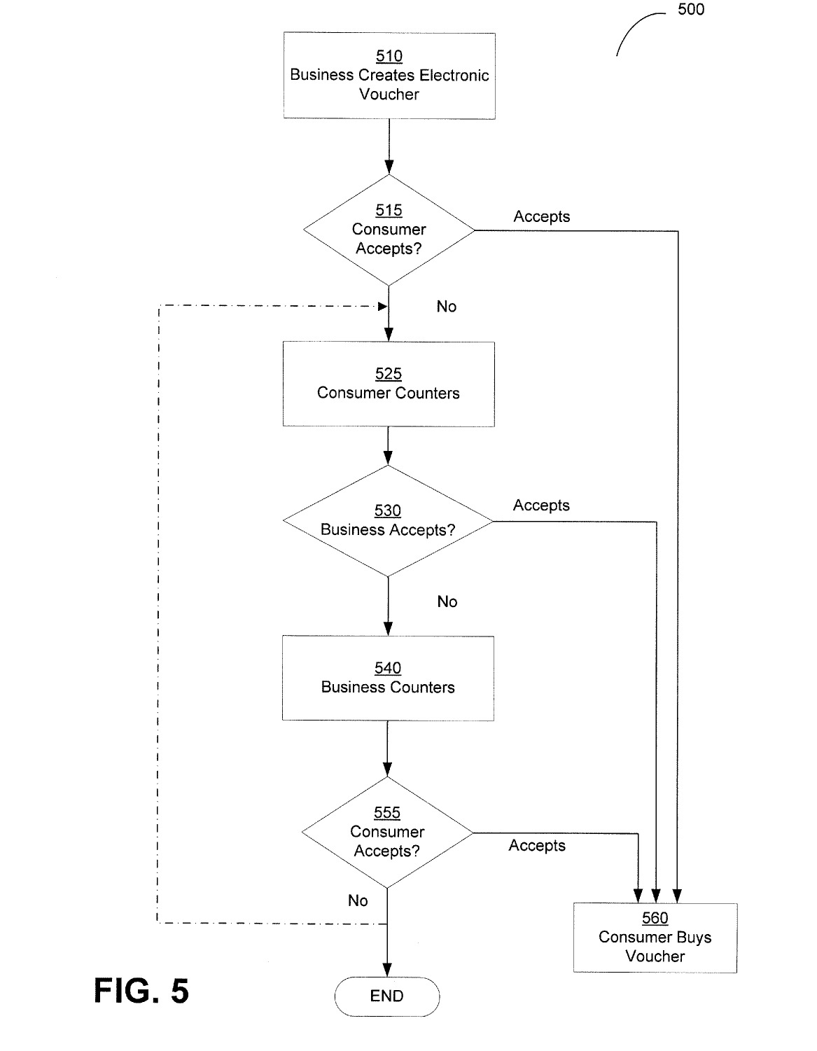

FIG. 5 illustrates a method of negotiating a voucher wherein the initial terms of the voucher are created by a business, according to some embodiments. A voucher may be created by a business when the business wishes to propose a potential transaction to consumers. For example, a business may wish to promote a particular service and may create a voucher that provides terms of a potential transaction with a consumer, e.g., the business may create a voucher wherein a consumer spending $100 or more on the business' service will receive a free gift, and may accordingly create a voucher with a price of $100 that can be exchanged for $100 of service with the business and the free gift.

In method 500, the business submits an electronic voucher to the system in act 510. This may be performed, for example, via the techniques described above in relation to FIG. 3, and submitting the electronic voucher to the system may make one or more details of the voucher, including the terms of the voucher, visible to at least some users of the system. For example, a business may create a voucher that all users are notified of (e.g., via e-mail), that is visible on a website (e.g., on the website's ‘front page’), and/or that targets a particular group of users (e.g., users that have expressed an interest in restaurant deals receive a text message), etc. The system may determine which notification technique(s) are used, if any, based on actions provided by a user representing the business when creating the voucher and/or by settings associated with an account of the user representing the business.

The electronic voucher submission may indicate the terms of the voucher created by the business. As described above, terms of a voucher may describe values of one or more parameters, such as price, a quantity of a good for which the voucher may be exchanged, a discounted rate for a good and/or service, a number and type of free goods and/or services, etc. The values of these parameters may, in some embodiments, define an initial offering of a voucher. Alternatively or additionally, the information provided in creating a voucher at act 510 may include criteria for acceptable terms of the voucher. These criteria may be used by the system to automatically negotiate terms of the voucher, if a user to which the voucher is made available does not accept the initial offering. The criteria for terms of a voucher may include indications of values of parameters in any suitable way, e.g., a static value, a value that depends on the value of one or more other parameters, a range of values, etc.

In act 515, a consumer may choose whether to accept the initial submission of the electronic voucher provided in act 510. The decision to accept or reject the submission of the voucher by the business associated with the business may be performed in any suitable way. For example, a user may click on an appropriate link provided by a website, the user may provide a text message to indicate the decision, etc. Choosing to accept the submission of the voucher may also include the consumer choosing to initiate a purchase of the voucher, e.g., a consumer may browse a website and may, upon viewing information associated with the voucher, may choose to purchase the voucher.

If the consumer does not accept (i.e., rejects) the electronic voucher submission, which may occur if the consumer does not wish to buy a voucher having the terms provided in the voucher, the consumer may provide a first proposal as a counter offer in act 525. Alternatively, the consumer may accept the terms of the voucher as provided by the business, in which case the consumer may buy the voucher in act 560, which is described in greater detail below.

The first proposal provided by the consumer via the counter offer in act 525 may include any suitable criteria, and may indicate terms of a voucher that the consumer is willing to accept, as described above. In act 530, the business chooses whether to accept the consumer's proposal. This decision may be based upon whether the first proposal meets the criteria for terms of the voucher specified by the business when creating the voucher submitted in act 410, as described above in relation to FIG. 2, and may thereby be performed automatically by the system or manually by the business. In cases where the decision is performed manually, the decision to accept or reject the submission of the first proposal by a user associated with the business may be performed in any suitable way. For example, a user may click on an appropriate link provided by a website, the user may provide a text message to indicate the decision, etc.

In cases where the response to the first proposal is provided automatically, the response may be based on one or more criteria. For example, a representative of the business may configure the system (e.g., by manipulating controls associated with the business' account) to accept or counter the submission of a proposal by a consumer based on the criteria provided in the voucher submission, which may be performed for some or all voucher submission criteria. For example, a business may configure the system (which may entail configuring account (e.g., preference) settings and/or may entail configuring the voucher created by the business in act 510) to automatically reject proposals that indicate a discount greater than 30% and to automatically accept proposals that indicate a discount lower than 5%. A representative of the business may then manually decide whether to accept, reject or counter vouchers that indicate a discount equal to or lower than 30% and equal to or greater than 5%. In another example, the business may configure the system to automatically accept proposals that indicate a discount lower than 10% and reject the proposal otherwise where the price of the voucher is below $100, and to automatically accept proposals that indicate a discount lower than 15% and reject the proposal otherwise where the price of the voucher is equal to or above $100. However, the above are provided merely as examples and in general any suitable scheme for automatically accepting, rejecting and/or countering the submission of a proposal may be used by a business.

As described above, the business may accept the terms of the voucher as provided by the first proposal in act 530, in which case the consumer may buy the voucher based on the terms of the first proposal in act 560, as described in greater detail below. If the business did not accept the first proposal, the business provides a second proposal as a counter offer in act 540. The second proposal provided by the business via the counter offer in act 540 may include any suitable criteria, and may indicate terms of a voucher that the business is willing to accept, as described above.

In act 555, the consumer chooses whether to accept the business' proposal provided in act 540. If the consumer chooses not to accept the proposal, method 500 may end. Though, in some embodiments, when a consumer chooses not to accept a proposal, method 500 may return to act 525 and further negotiation may be conducted.

Conversely, the consumer may instead accept the terms of the voucher as provided by the business, in which case the consumer may buy the voucher in act 560, as described in greater detail below.

In act 560, the consumer may buy the voucher having terms as dictated by the negotiation process described above. That is, in the example of FIG. 5, the terms of the voucher that may be purchased in act 560 may be determined by the electronic voucher created by the business in act 510, the counter proposal provided by the consumer in act 525 or the counter proposal provided by the business in act 540. Irrespective of how the terms of the voucher for purchase were determined, in act 560 the consumer buys the voucher having these terms. The purchase process may use any suitable technique(s) in which the consumer provides payment information and receives delivery of the voucher, such as those described above in relation to FIG. 3.

It should be appreciated that a negotiation process may include any number of proposals and negotiation steps, and that the exemplary method provided by FIG. 5 merely indicates one such process. In general, a negotiation process may continue indefinitely with a business and consumer repeatedly providing counter proposals until either the business or the consumer accepts a proposal. In some embodiments, the system is configured to impose constraints on the negotiation process, such as a limit on the number of proposals that may be provided in a negotiation between a consumer and a business, which may encourage consumers and businesses to promptly determine terms of a voucher that is agreeable to both parties.

Furthermore, the voucher purchased by the consumer in act 560 may be made available for purchase to other users, as described above in relation to FIG. 4. This may be performed, for example, by providing details of the voucher for purchase on a website, though may also be made available via one or more applications running on any suitable device (e.g., client computer, tablet computer, mobile phone, etc.) and/or a social networking website and/or application. These details may be made available by the system, the business or by the consumer. In cases in which the voucher is made available by the consumer, an incentive may be offered by the system for encouraging others to purchase such a voucher. For example, coded links or other techniques may be used to associate a voucher with a user entitled to receive an incentive when other users purchase the voucher such that the amount of incentive do any user for negotiating the voucher. Alternatively or additionally, incentives can be offered for other actions, such as initially creating a voucher.

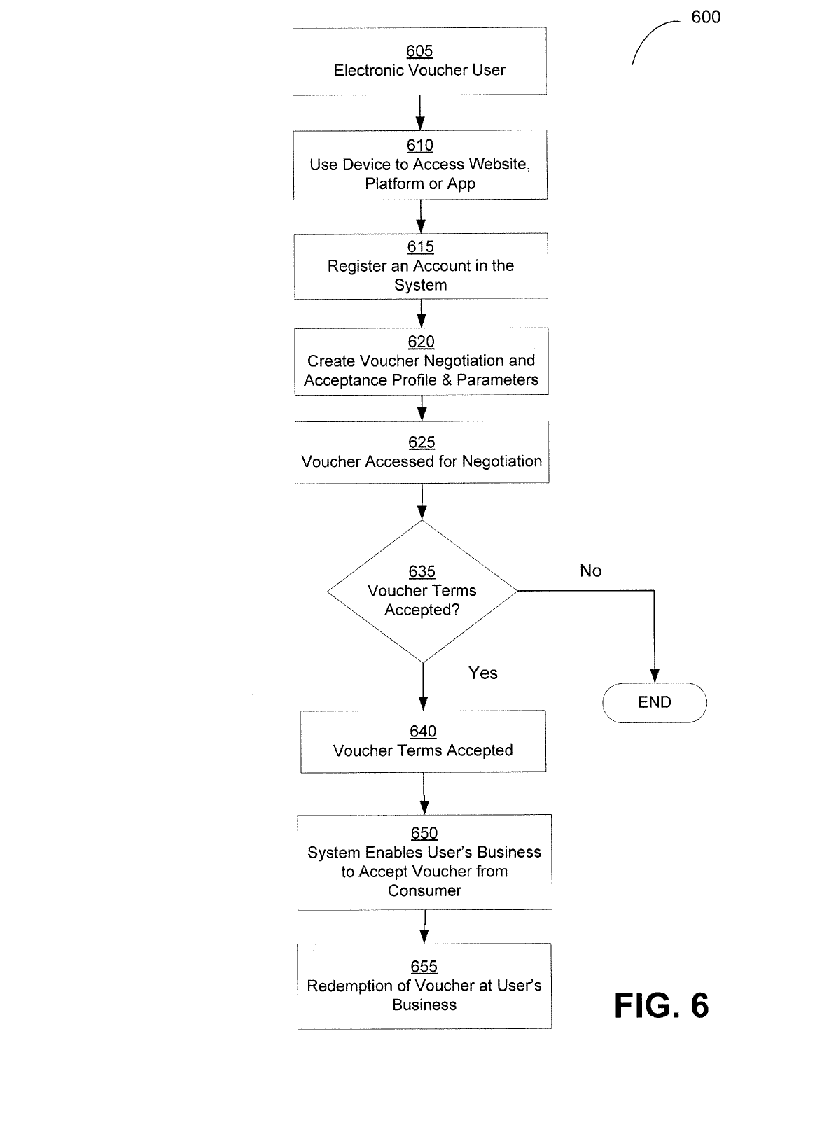

FIG. 6 illustrates a method of negotiating a voucher, according to some embodiments. As a specific example, method 600 may entail a user who is a representative of a business interacting with a negotiation system as described above. In method 600, the user uses a device to access a system (act 610) and register an account in the system (act 615), examples of techniques for which are described above. In act 620, the user creates a voucher negotiation and acceptance profile and parameters, which may be used to automatically determine whether to accept, reject or counter a proposal and/or electronic voucher submission during negotiation of the terms of a voucher, as described above. In some embodiments, the information specified in act 620 may relate to a specific affinity group. However, in other embodiments, the information provided in the profile created the next 620 may control actions by the negotiation system whenever engaged in negotiation of a voucher on behalf of the user. These parameters, for example, may specify such characteristics of the negotiation as the maximum number of iterations in any negotiation, delays between proposals made by the system, a number of counterproposals the system will accept from a consumer before making a proposal including the most favorable terms consistent with criteria specified for a voucher, an amount of change in a counter proposals made by a consumer before the system will make a modified proposal, etc. Though, it should be appreciated that any suitable characteristics may be included in the profile.

Regardless of the terms in the profile, the profile may be used in the negotiation of terms for a specific affinity group. At act 625, a voucher is accessed for negotiation. The voucher may be accessed in any suitable way, including, for example, in response to an indication of interest from a consumer in a voucher for an offer that has been posted to the system.

In act 635, the voucher negotiation and acceptance profile and characteristics specified in conjunction with the voucher for negotiation are used to determine whether to accept the terms of a voucher proposed by a consumer. If the voucher terms are accepted (act 640), the system enables the user's business to accept the voucher from a consumer (act 650).

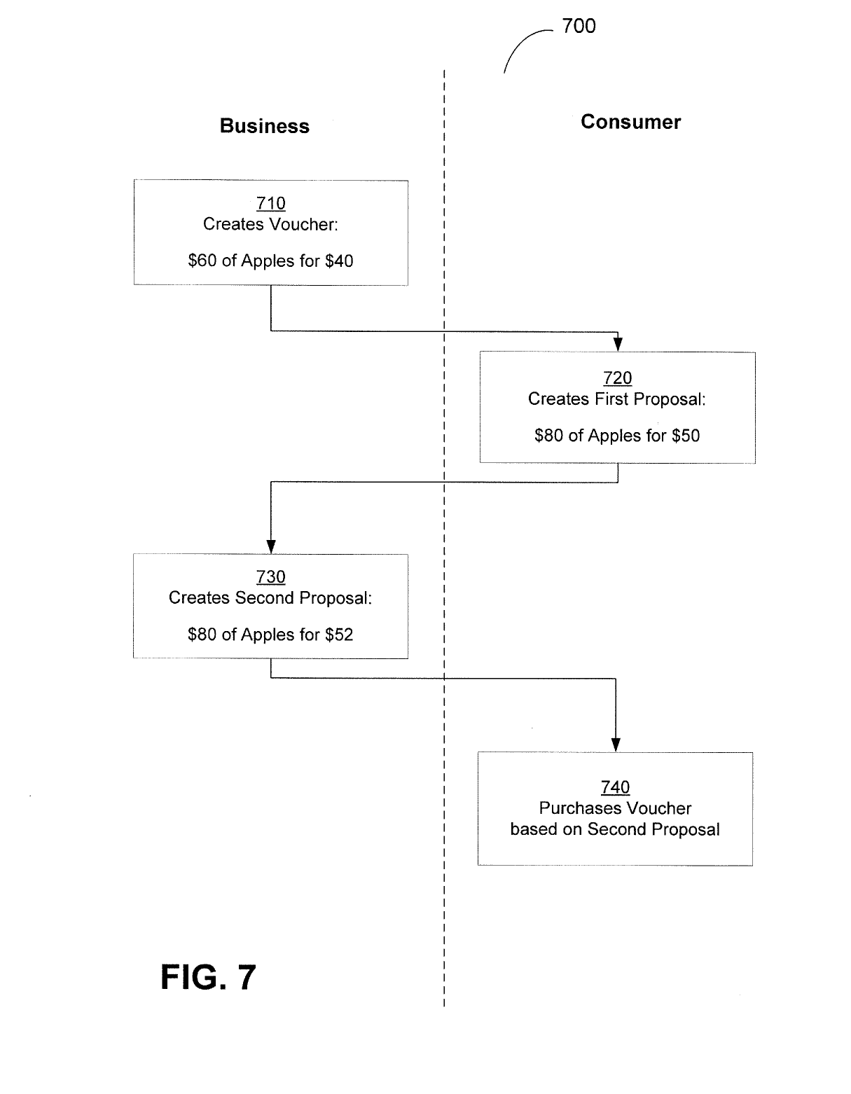

FIG. 7 illustrates an exemplary process of a consumer and a business negotiating a voucher, in accordance with some embodiments. FIG. 7 provides an example of the terms that may be varied in proposals and counterproposals for a voucher, but it should be appreciated that any suitable terms may be varied. In method 700, a business creates a voucher in act 710 that is associated with an offer to sell apples to consumers. The terms of the voucher include the price of the voucher ($40) and the value of the apples that redemption of the voucher will provide to the holder of the voucher ($60). It will be appreciated that the same voucher terms could be expressed in a plurality of ways, such as by specifying the price of the voucher ($40) and the discounted rate (33.3%), etc. The voucher created in act 710 may be created in any suitable way, including using those techniques described above.

In act 720, the consumer creates a proposal for terms of the voucher that differ from the terms supplied by the system on behalf of a business. The proposal created in act 720 may be created in any suitable way, including using those techniques described above. The proposal created in act 720 describes proposed terms for the voucher, being the price of the voucher ($50) and the value of the apples that redemption of the voucher will provide to the holder of the voucher ($80). As described above, the same voucher terms may also be expressed in any other suitable way, such as by specifying the price of the voucher ($50) and the discounted rate (37.5%), etc.

In act 730, the business creates a second proposal. This may occur if the business does not wish to sell a voucher having the terms provided in the first proposal in act 720. The decision of the business to not accept the first proposal, and to create a second proposal, may be based upon whether the first proposal meets the criteria for terms of the voucher specified by the business when creating the voucher submitted in act 710, as described above, and may thereby be performed automatically by the system or manually by the business. In cases where the decision is performed manually, the decision to accept or reject the submission of the first proposal by a user associated with the business may be performed in any suitable way. For example, a user may click on an appropriate link provided by a website, the user may provide a text message to indicate the decision, etc.

The second proposal created in act 730 describes proposed terms for the voucher, being the price of the voucher ($52) and the value of the apples that redemption of the voucher will provide to the holder of the voucher ($80). As described above, the same voucher terms may also be expressed in any other suitable way, such as by specifying the price of the voucher ($52) and the discounted rate (35%), etc.

In act 740, the consumer purchases the voucher based on the terms of the second proposal provided by the business in act 730. It should be appreciated that a negotiation process may include any number of proposals and negotiation steps, and that the exemplary method provided by FIG. 7 merely indicates one such process. In general, a negotiation process may continue indefinitely with a business and consumer repeatedly providing counter proposals until either the business or the consumer accepts a proposal.

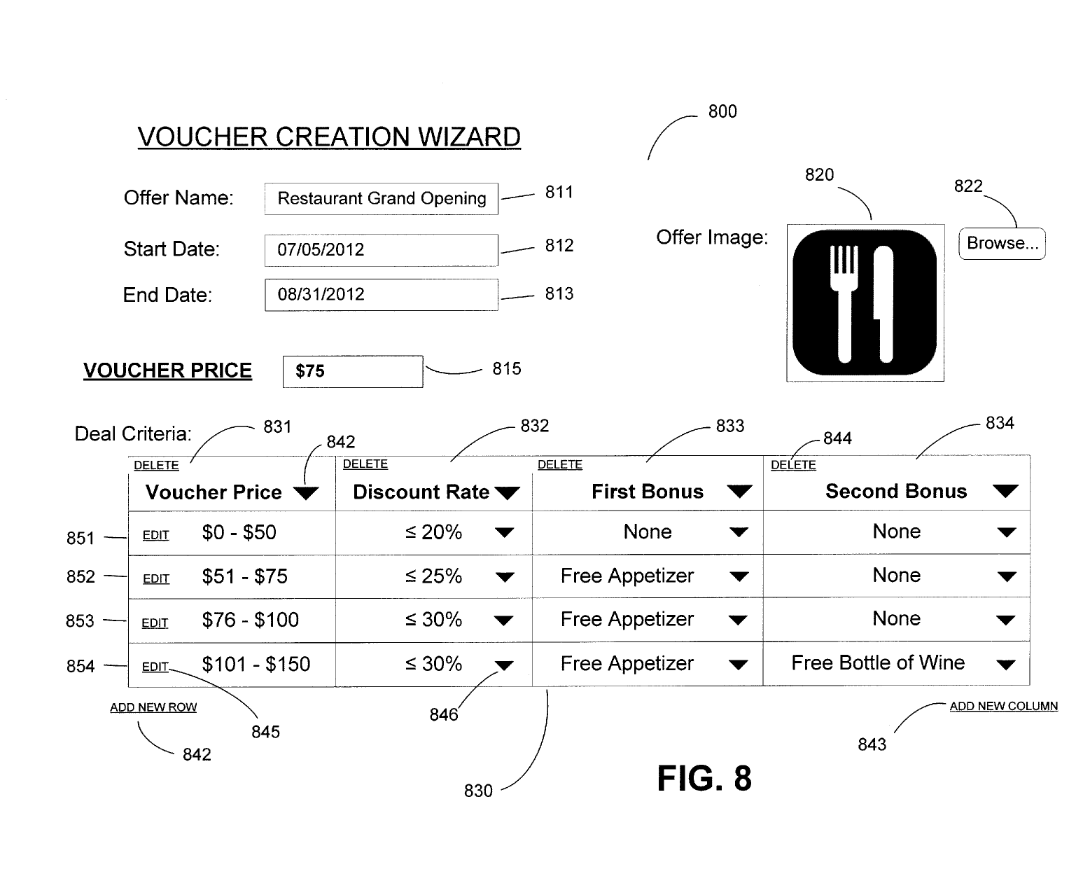

A voucher may be created in any suitable way. For example, a voucher may be created in a scripting language or otherwise as computer executable code that defines a process of negotiation. Alternatively or additionally, a voucher may include a tag the data set or may be represented as a database or other data structure. Though, the information defining a voucher may be obtained in any suitable way. FIG. 8 illustrates a schematic view of an exemplary interface for creating and configuring a voucher, in accordance with some embodiments. User interface 800 may be provided via any suitable means, including a website, an application running on a computer, mobile phone, tablet computer, mobile phone, etc. and may send and receive data from any number of sources in order to create and configure a new voucher. Data representing the new voucher may be created on any system, including the system generating the user interface, a database server, a web server, a storage device coupled to a web server, etc.

In the example of FIG. 8, the user interface is configured for use by a business to create a voucher. Accordingly, the user interface may receive information about an offer with which the voucher is associated and criteria for terms of the voucher that would be acceptable to the business. Information collected through such a user interface may be stored electronically in a system, such as system 100 (FIG. 1). Though, it should be appreciated that the specific representation of a voucher is not critical to the invention.

In this example, user interface 800 includes data entry fields 811-813, which may be used by the creator of the voucher to provide details about the voucher. Data entry field 811 may be used to indicate the name of the offer associated with the voucher to be created, which may be used, for example, by a website displaying information about the offer such that the offer name is visible to consumers browsing the web site. Data entry fields 812 and 813 provide start and end dates, respectively, which may be used to define a period in which the offer is valid (e.g., when the offer is available for purchase). Information provided when creating a voucher in data entry fields 811-813 may be used by the system to provide further functionality to both the user that created the voucher, and to other users. For example, the start date provided in data entry field 812 may be used by an application to determine when to make the voucher visible to consumers for purchase, etc.

User interface 800 includes offer image field 820, which may be used by the creator of the voucher to provide an image to be associated with the voucher. For example, an application may indicate the voucher to a user by displaying the image provided via image field 820 in proximity to the offer name provided by data entry field 811. The offer image field may be populated by a user via button 822, which may allow a user of the user interface to select an image file from one or more locations (e.g., stored on a device, stored at a location accessible via the Internet, etc.).

User interface 800 includes voucher price field 825, which may be used by the creator of the voucher to specify the price of the voucher. In the example of FIG. 8, further terms of the voucher are specified via configuration section 830, to be described below, although in general any technique for specifying the terms of the voucher may be used. For example, user interface 800 may include additional fields to be used by the creator of the voucher to input other criteria, such as a discount rate, the value of the voucher (i.e., the value of the goods and/or services for which the voucher may be redeemed), and/or any other suitable criteria.

User interface 800 includes configuration section 830, which may be used by the creator of the voucher to specify terms that the user is willing to accept in response to a proposal from a consumer, and to define the terms of the voucher to be provided to consumers, both of which are described in further detail below. Configuration section 830 includes columns 831-834, which each define a parameter to be used to specify the terms of the voucher that the user is willing to accept and/or to define the terms of the voucher to be provided to consumers. In user interface 800, the parameters used in each of columns 831-834 are configurable via buttons, such as button 842, which may, for example, allow a user to choose the parameter used in each column from a list (e.g., a drop-down list). Any number of parameters may be used to define criteria in configuration section 830, and columns may be added or removed as desired by the user, for example via links 843 and 844, respectively. In this way, configuration section 830 allows a user to choose a set of parameters to be used to specify terms that the user is willing to accept in response to a proposal from a consumer, and to define the terms of the voucher to be provided to consumers.

Configuration section 830 may be used to specify values, or ranges of values, for each parameter shown in columns 831-834 via each of the cells located at the intersection of a row and column. For example, in the cell at the intersection of column 831 (in which the price of the voucher is used as the parameter) and row 851, the price of the voucher is specified as being between $0 and $50. Each cell may be edited by the user, for example via an edit button, such as edit button 845, and/or by a drop-down button, such as drop-down button 846.

Configuration section 830 may thereby be used to specify criteria for the possible terms the user is willing to accept in response to a proposal from a consumer. For example, a proposal from a consumer for a voucher with a price of $80 having a discount rate of 28% may be acceptable to the business based on the criteria specified in row 853 (since column 832 in that row indicates the discount rate to be less than or equal to 30%). Similarly, a proposal from a consumer for a voucher with a price of $75 having a discount rate of 30% and including a free appetizer may not be acceptable to the business, based on the criteria specified in row 852 (since column 832 in that row indicates the discount rate to be less than or equal to 25%). The criteria specified in configuration section 830 may be used to automatically respond to a proposal from a consumer, techniques and methods for which are described above.

Configuration section 830 may be used to define the terms of the voucher to be provided to consumers. For example, the criteria specified in the configuration section may be used with voucher price field 825 to determine the criteria for terms of the voucher made available to consumers. In the example of FIG. 8, voucher price field 825 indicates a price of $75, and configuration section 830 indicates in row 852 that a price of $75 provides a maximum discount of 25% and provides a free appetizer. These criteria may be used to configure the terms of the voucher with the maximum available discount and with the bonus item. The data shown in user interface 800 may thereby be used to create a voucher having a price of $75, a discount rate of $25% (and therefore a redeemable value of $100), and a bonus of a free appetizer. Consumers may choose to purchase the voucher with these terms, or may provide a proposal for alternative terms, techniques and methods for which are described above. Where a proposal is provided, the criteria in configuration section 830 may be used to automatically respond to the proposal, as described above.

It should be appreciated that a user interface that may be used to create a voucher may include any number of controls of any type, including buttons, radio buttons, drop-down lists, comboboxes, check boxes, datagrids, cycle buttons, text boxes, etc. Furthermore, the configuration of the user interface (i.e., which controls are included, where they are located, etc.) may depend on whether the user is identified as a consumer and/or a representative of a business. In addition, the system may provide for modification of the configuration of the user interface by a user, for example so that each user may personalize the user interface to suit their needs and/or taste.

In some embodiments, the criteria in configuration section 830 may be saved by the user to allow the user to use the same criteria when creating another voucher without having to re-enter the same information. This may be useful, for example, to save time when creating multiple vouchers where it is desirable to use the same criteria that describes the terms the user is willing to accept in response to a proposal from a consumer, for more than one voucher.

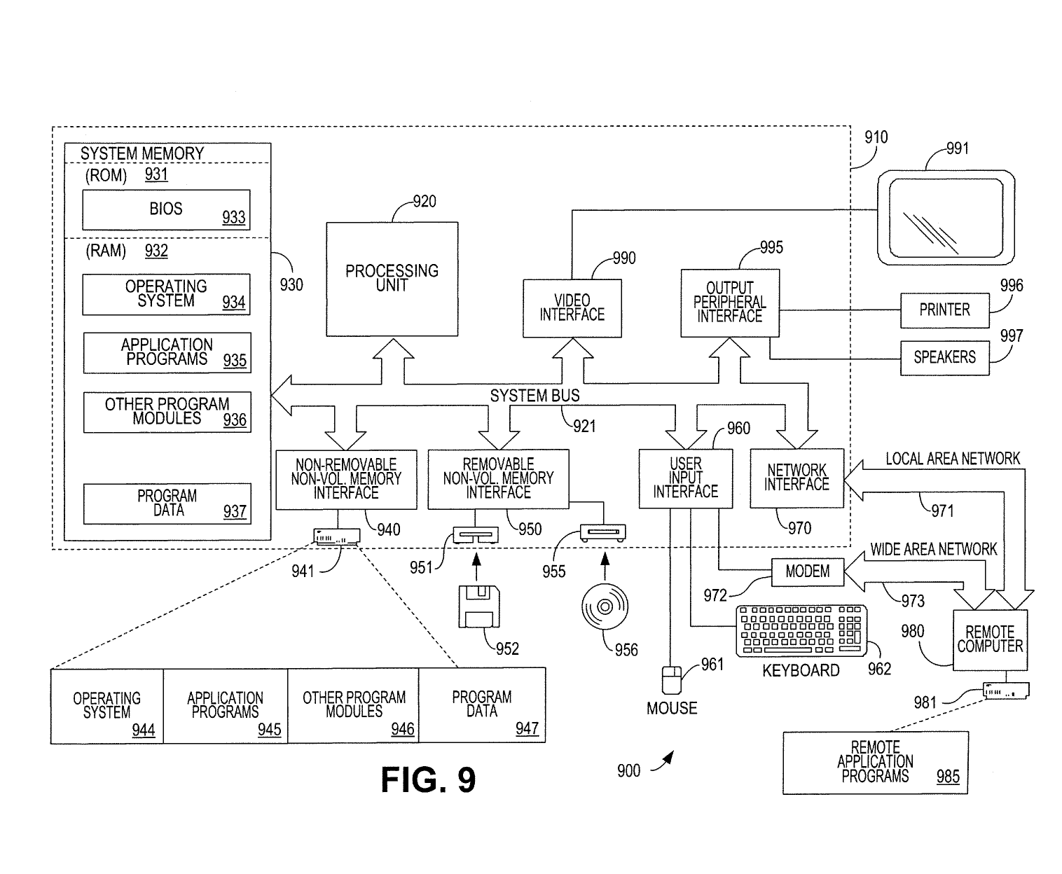

FIG. 9 illustrates an example of a suitable computing system environment 900 on which the invention may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through an non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through a output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non- transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of operating a system for creating and negotiating a voucher, comprising steps of:
with at least one server:
receiving from a first user, an identification of an offer and criteria for terms of a voucher associated with the offer;
presenting to a second user an identification of the offer;
receiving from the second user a first proposal for terms of the voucher; and
sending a response to the second user based on a comparison of the first proposal with the criteria for terms of the voucher, the response comprising:
when the first proposal meets the criteria for terms of the voucher, an indication that the first proposal is accepted; and
when the first proposal does not meet the criteria for terms of the voucher, a second proposal.

2. The method of claim 1, further comprising:
generating the second proposal based on the first proposal and the criteria for terms of the voucher.

3. The method of claim 2, wherein:
the offer comprises an offer to sell a first product; and
the criteria for terms of the voucher comprise one or more of: a quantity of the first product, a price of the first product and/or at least one other product to purchase in conjunction with the first product.

4. The method of claim 2, wherein:
the offer comprises a discount for goods or services provided by the first user; and
the criteria for terms of the voucher comprise one or more of: an amount of a discount and/or a discounted price of the goods or services.

5. The method of claim 2, wherein:
the criteria for terms of the voucher comprise a plurality of ranges for a first parameter; and
at least one of the plurality of ranges for the first parameter is dependent on a value of a second parameter.

6. The method of claim 5, wherein:
generating the second proposal based on the first proposal and the criteria for terms of the voucher comprises selecting a value for the first parameter from a range determined by a value of the second parameter included in the first proposal.

7. The method of claim 6, wherein:
the first parameter is the price of the voucher; and
the second parameter is an indication of a discount obtainable with the voucher.

8. The method of claim 1, further comprising:
when the first proposal meets the criteria for terms of the voucher, providing to the second user a link to a website at which a voucher in accordance with the first proposal can be acquired.

9. The method of claim 8, further comprising:
providing a reward to the second user based on a third user activating the link to purchase the voucher through the website in accordance with the first proposal,
wherein the link is encoded to identify the second user.

10. The method of claim 1, wherein:
the first user represents a business and the second user represents a customer or potential customer of the business.

11. The method of claim 1, wherein:
the first user and/or the second user is provided an account at a website at which a voucher in accordance with the first proposal can be acquired.

12. The method of claim 1, further comprising:
collecting funds from the first user and/or the second user based on the first proposal meeting the criteria for terms of the voucher.

13. The method of claim 2, further comprising:
collecting funds from the first user and/or the second user based on generating the second proposal.

14. The method of claim 1, wherein:
a third user monitors one or more of said acts of receiving, presenting and sending.

15. A system comprising:
at least one server configured to:
store an offer;
store criteria for terms of a voucher associated with the offer;
receive a first proposal for terms of the voucher from a first user; and
send a response to the first user based on a comparison of the first proposal with the criteria for terms of the voucher, the response comprising:
when the first proposal meets the criteria for terms of the voucher, an indication that the first proposal is accepted; and
when the first proposal does not meet the criteria for terms of the voucher, a second proposal.

16. The system of claim 15, further comprising:
generating the second proposal based on the first proposal and the criteria for terms of the voucher.

17. The system of claim 16, wherein:
the offer comprises an offer to sell a first product; and
the criteria for terms of the voucher comprise one or more of: a quantity of the first product, a price of the first product and/or at least one other product to purchase in conjunction with the first product.

18. The system of claim 16, wherein:
the criteria for terms of the voucher comprise a plurality of ranges for a first parameter; and
at least one of the plurality of ranges for the first parameter is dependent on a value of a second parameter.

19. The system of claim 18, wherein:
generating the second proposal based on the first proposal and the criteria for terms of the voucher comprises selecting a value for the first parameter from a range determined by a value of the second parameter included in the first proposal.

20. A tangible computer-readable medium having a plurality of instructions embodied therein, wherein the plurality of instructions, when executed by a processor, cause a machine to perform a method of:
obtaining an offer and criteria for terms of a voucher associated with the offer;
receiving from a first user a first proposal for terms of the voucher; and
sending a response to the first user based on a comparison of the first proposal with the criteria for terms of the voucher, the response comprising:
when the first proposal meets the criteria for terms of the voucher, an indication that the first proposal is accepted; and
when the first proposal does not meet the criteria for terms of the voucher, a second proposal.

21. The tangible computer-readable medium of claim 20, further comprising:
generating the second proposal based on the first proposal and the criteria for terms of the voucher.

22. The tangible computer-readable medium of claim 21, wherein:
the offer comprises an offer to sell a first product; and
the criteria for terms of the voucher comprise one or more of: a quantity of the first product, a price of the first product and/or at least one other product to purchase in conjunction with the first product.

23. The tangible computer-readable medium of claim 21, wherein:
the offer comprises a discount for goods or services provided by the first user; and
the criteria for terms of the voucher comprise one or more of: a value of the voucher and/or a discounted price of the voucher.

24. The tangible computer-readable medium of claim 21, wherein:
the criteria for terms of the voucher comprise a plurality of ranges for a first parameter; and
at least one of the plurality of ranges for the first parameter is dependent on a value of a second parameter.

25. The tangible computer-readable medium of claim 24, wherein:
generating the second proposal based on the first proposal and the criteria for terms of the voucher comprises selecting a value for the first parameter from a range determined by a value of the second parameter included in the first proposal.
